(19) United States
(12) Patent Application Publication
(10) Pub. No.: US 2015/0321295 A1
(43) Pub. Date: Nov. 12, 2015

(54) LLT WELDING CONSUMABLES

(71) Applicant: Lincoln Global, Inc., City of Industry, CA (US)

(72) Inventors: Vincent van der Mee, Nijmegen (NL); Bert Kalfsbeek, Elst (NL)

(21) Appl. No.: 14/680,703

(22) Filed: Apr. 7, 2015

Related U.S. Application Data
(60) Provisional application No. 61/989,643, filed on May 7, 2014.

(51) Int. Cl. B23K 35/30

(52) U.S. Cl. CPC B23K 35/3086

(57) ABSTRACT

The core of a metal cored welding electrode is formulated with a specific Cr/Ni-rich or Cr/Mn-rich composition. The welds produced when this electrode is used for welding high strength steels exhibits sufficient fatigue resistance so that subsequent PWHT or other post-weld treatment procedures is unnecessary.

### RELATED APPLICATION

The present application is being filed as a non-provisional patent application claiming priority/benefit under 35 U.S.C. §119(e) from U.S. Provisional Patent Application No. 61/989,643 filed on May 7, 2014, the entire disclosure of which is incorporated herein by reference.

### BACKGROUND

Heavy equipment such as cars, trucks, cranes, bridges, roller coasters, presses, and other structures that handle large amounts of stress or need good strength-to-weight ratios are normally made from high strength steels.

When such products are made, it is normally necessary to join two or more sections of high strength steel by welding. For this purpose, metal cored welding electrodes are normally used whose filler material, i.e., the metal composition forming the core of the electrode, is formulated to produce a weld metal also exhibiting high strength as well as high toughness. G89 according to EN ISO 16834 is an example of such a metal composition.

Unfortunately, the welds produced by such conventional metal cored welding electrodes may exhibit poor fatigue resistance in their as-welded condition. In addition, such welds may also exhibit poor cold cracking resistance in their as-welded condition. As a result, such welds are normally subjected to Post Weld Heat Treatment (PWHT) or other post-welding procedure.

### SUMMARY OF THE INVENTION

In accordance with this invention, it has been found that welds exhibiting the strength and toughness necessary for welding high strength steels as well as substantial fatigue resistance in their as-welded condition can be produced by using a metal cored welding electrode whose core has a particular chemical composition.

Thus, this invention in one embodiment provides a metal cored welding electrode for welding high strength steels, this metal cored welding elected being formulated to produce an undiluted weld metal having an Cr/Ni-rich composition comprising ≦0.06 wt % C, 3.0-7.0 wt % Ni, 9.0-14.0 wt. % Cr, ≦1.0 wt % Mn, ≦1.0 wt % Si, ≦0.05 wt % Ti, ≦0.05 wt % Al, ≦0.05 wt % S, with the balance being Fe and incidental impurities.

In a second embodiment, this invention provides another metal cored welding electrode for welding high strength steels, this metal cored welding elected being formulated to produce an undiluted weld metal having an Cr/Mn-rich composition comprising ≦0.10 wt % C, ≦1.0 wt % Ni, 8.0-13.0 wt. % Cr, 4.0-10.0 wt % Mn, ≦1.0 wt % Si, ≦0.05 wt % Ti, ≦0.05 wt % Al, ≦0.05 wt % S, with the balance being Fe and incidental impurities.

In addition, this invention also provides a process for joining two or more metal sections made from high strength steels by non-autogenous welding, in which the welding electrode used to carry out the welding process is one or the other of the above metal cored welding electrodes.

### DETAILED DESCRIPTION

In accordance with this invention, new metal cored welding electrodes (or “consumables”) are used to weld two or more metal sections of high strength steels. Because of their metallurgy, the welds produced by these consumables exhibit a Low Temperature Transformation (LTT) temperature (low martensite transformation temperature) in the range of 150° C. to 300° C. in their as-welded condition. As a result, these welds exhibit compressive rather than tensile stresses in their as-welded condition, even when multipass welds are made. Accordingly, these welds exhibit improved fatigue strengths, even though they have not been subjected to post weld heat treatment.

In order to achieve good fatigue strength, welds made from conventional consumables, especially multipass welds, need to be heat treated to relieve internal tensile stresses. In some instances, especially when larger multipass welds are made, such post weld heat treatments are difficult and/or ineffective due to the physical inaccessibility of portions of the weld. This problem is avoided in connection with this invention, because the welds produced by the inventive consumables already exhibit compressive rather than tensile stresses due to their metallurgy.

Thus, the Low Temperature Transformation (LTT) welding consumables of this invention offer the potential of achieving improved fatigue strength, especially in multipass welds, without the time and cost of extensive post weld treatments. Thus, the Low Temperature Transformation (LTT) welding consumables of this invention open up the possibility to produce favorable residual stresses even in areas of a weld joint which are difficult to access. Moreover, volume-like compressive residual stress fields in the weld metal and HAZ may be produced contrary to conventional treatment methods which are mainly limited to surface areas.

### High Strength Steel

The LTT welding consumables of this invention are desirably used to weld two or more metal sections of high strength steels.

“High-strength steel (HSS),”, is a type of steel that provides higher strength levels compared to standard mild steel. Typical Yield strength varies from 460 MPa to 960 MPa. HSS steels vary from other steels in that they are not made to meet a specific chemical composition but rather to specific mechanical properties. They typically have a carbon content between 0.05-0.25 wt. % to retain formability and weldability.

Other alloying elements include up to 2.0% manganese and small quantities of one or more of the following elements: copper, nickel, niobium, nitrogen, vanadium, chromium, molybdenum, titanium, calcium, rare earth elements, or zirconium. Copper, titanium, vanadium, and niobium can be added for strengthening purposes. These elements are intended to alter the microstructure of carbon steels. High strength steels, depending on strength level, can be made 20 to 50% lighter than standard carbon steels of the same strength. In addition, the properties of many high strength steels can be improved by various post casting treatments such as tempering, precipitation hardening and the like. Yield strengths from 460 up to 960 MPa (36,000-86,000 psi) can be achieved.

### Structure

The inventive metal cored welding electrodes have the same structure as conventional metal cored welding electrodes for welding high strength steels in that they comprise a core formed from a mixture of desired metals and an outer metal sheath surrounding the core. They may be made in a conventional way, such as by beginning with a flat metal strip made from an Fe-based alloy appropriate for making metal cored electrodes for welding high strength steels such as, for example, Al- or Si-killed mild steel The flat metal strip is then formed into a “U” shape, for example, as shown in Bernard U.S. Pat. No. 2,785,285, Sjoman U.S. Pat. No. 2,944,142, and Woods U.S. Pat. No. 3,534,390, after which the metals forming the metal core, as well as any other core fill materials that may optionally be present, are then deposited into the “U.” The strip is then closed into a tubular configuration by a series of forming rolls, after which the tube so formed is normally drawn or rolled through a series of dies to reduce its cross-section and set its final diameter.

If desired, the electrode so formed can be coated with a suitable feeding lubricant, wound onto a spool, and then packaged for shipment and use.

### Weld Deposit Composition

The inventive metal cored welding electrode is formulated so that the undiluted weld produced by this electrode has the chemical composition set forth in the following Table 1. As appreciated in the art, the undiluted weld deposit composition of a welding electrode is the composition of the weld produced without contamination from any other source. It is normally different from the chemical composition of the weld metal obtained when the electrode is used to weld a workpiece, which weld metal can typically be diluted with as much as 20%, of the base material being welded.

TABLE 1
Weld Deposit Composition, wt. %

| | Cr/Ni-Rich Electrode | | | Cr/Mn-Rich Electrode | | |
|---|---|---|---|---|---|---|
| Ingredient | Good | Better | Best | Good | Better | Best |
| Carbon | ≦0.0.06 | ≦0.0.5 | ≦0.045 | ≦0.10 | ≦0.090 | ≦0.085 |
| Nickel | 3.0-7.0 | 4.0-6.0 | 4.5-5.0 | ≦1.0 | ≦0.50 | ≦0.10 |
| Chromium | 9.0-14.0 | 10.5-13.0 | 11.5-12.6 | 8.0-13.0 | 9.5-12.0 | 10.5-11.5 |
| Manganese | ≦1.0 | ≦0.85 | ≦0.70 | 4.0-10.0 | 5.0-8.5 | 6.0-7.5 |
| Silicon | ≦1.0 | ≦0.7 | ≦0.4 | ≦1.0 | ≦0.60 | ≦0.35 |
| Titanium | ≦0.05 | ≦0.03 | ≦0.015 | ≦0.05 | ≦0.03 | ≦0.015 |
| Aluminum | ≦0.05 | ≦0.035 | ≦0.025 | ≦0.05 | ≦0.035 | ≦0.025 |
| Sulfur | ≦0.05 | ≦0.035 | ≦0.025 | ≦0.05 | ≦0.035 | ≦0.025 |
| Iron | balance | balance | balance | balance | balance | balance |

### Properties

The undiluted welds produced by the inventive metal cored electrode, both the Cr/Ni-rich version and the Cr/Mn-version, exhibit a desirable combination of properties in their as-welded condition. For example, they exhibit better compressive stresses when used to make multipass welds due to a low martensite transformation temperature of the weld metal.

### EXAMPLES

In order to more thoroughly describe this invention, the following working examples are provided. In these working examples, the welds produced by two different metal cored welding electrodes made in accordance with this invention in their as-welded condition were tested for fatigue resistance. In this test, longitudinal welds are fatigue tested axially. Weld detail in the test specimen is classified as FAT63 in the IIW fatigue design recommendations.

Two electrodes made in accordance with this invention were tested, a Cr/Ni-Rich Electrode and a Cr/Mn-Rich Electrode. Their chemical compositions, in terms of the undiluted weld deposits they produce, are set forth in the following Table 2.

TABLE 2
Weld Deposit Composition, wt. %

| Ingredient | Cr/Ni-Rich | Cr/Mn-Rich |
|---|---|---|
| Carbon | 0.042 | 0.079 |
| Nickel | 4.7 | 0.03 |
| Chromium | 12.1 | 11.2 |
| Manganese | 0.64 | 6.8 |
| Silicon | 0.31 | 0.25 |
| Titanium | 0.008 | 0.007 |
| Aluminum | 0.015 | 0.014 |
| Sulfur | 0.015 | 0.015 |
| Iron | balance | balance |

The results of these tests indicate that in the fatigue strength of the welds made with the inventive metal cored welding electrodes may be improved by a factor of 2 relative to welds made by conventional welding electrodes.

Although only a few embodiments of this invention have been described above, it should be appreciated that many modifications can be made without departing from the spirit and scope of the invention. All such modifications are intended to be included within the scope of this invention, which is to be limited only by the following claims.

1. A metal cored welding electrode for welding high strength steels, the metal cored welding elected being formulated to produce an undiluted weld metal having a Cr/Ni-rich composition or a Cr/Mn-rich composition,
wherein the Cr/Ni-rich composition comprises ≦0.06 wt % C, 3.0-7.0 wt % Ni, 9.0-14.0 wt. % Cr, ≦1.0 wt % Mn, ≦1.0 wt % Si, ≦0.05 wt % Ti, ≦0.05 wt % Al, ≦0.05 wt % S, with the balance being Fe and incidental impurities, and
wherein the Cr/Mn-rich composition comprises ≦0.10 wt % C, ≦1.0 wt % Ni, 8.0-13.0 wt. % Cr, 4.0-10.0 wt % Mn, ≦1.0 wt % Si, ≦0.05 wt % Ti, ≦0.05 wt % Al, ≦0.05 wt % S, with the balance being Fe and incidental impurities.

2. The metal cored welding electrode of claim 1, wherein the metal cored welding elected is formulated to produce an undiluted weld metal having a Cr/Ni-rich composition comprising ≦0.06 wt % C, 3.0-7.0 wt % Ni, 9.0-14.0 wt. % Cr, ≦1.0 wt % Mn, ≦1.0 wt % Si, ≦0.05 wt % Ti, ≦0.05 wt % Al, ≦0.05 wt % S, with the balance being Fe and incidental impurities.

3. The metal cored welding electrode of claim 2, wherein the metal cored welding elected is formulated to produce an undiluted weld metal having a Cr/Ni-rich composition comprising ≦0.05 wt % C, 4.0-6.0 wt % Ni, 10.5-13.0 wt. % Cr, ≦0.85 wt % Mn, ≦0.70 wt % Si, ≦0.03 wt % Ti, ≦0.35 wt % Al, ≦0.35 wt % S, with the balance being Fe and incidental impurities.

4. The metal cored welding electrode of claim 3, wherein the metal cored welding elected is formulated to produce an undiluted weld metal having a Cr/Ni-rich composition comprising ≦0.045 wt % C, 4.5-5.0 wt % Ni, 11.5-12.6 wt. % Cr, ≦0.7 wt % Mn, ≦0.4 wt % Si, ≦0.015 wt % Ti, ≦0.025 wt % Al, ≦0.025 wt % S, with the balance being Fe and incidental impurities.

5. The metal cored welding electrode of claim 1, wherein the metal cored welding elected is formulated to produce an undiluted weld metal having a Cr/Mn-rich composition comprising ≦0.10 wt % C, ≦1.0 wt % Ni, 8.0-13.0 wt. % Cr, 4.0-10.0 wt % Mn, ≦1.0 wt % Si, ≦0.05 wt % Ti, ≦0.05 wt % Al, ≦0.05 wt % S, with the balance being Fe and incidental impurities.

7. The metal cored welding electrode of claim 6, wherein the metal cored welding elected is formulated to produce an undiluted weld metal having a Cr/Mn-rich composition comprising ≦0.09 wt % C, ≦0.5 wt % Ni, 9.5-12.0 wt. % Cr, 5.0-8.0 wt % Mn, ≦0.60 wt % Si, ≦0.03 wt % Ti, ≦0.035 wt % Al, ≦0.035 wt % S, with the balance being Fe and incidental impurities.

8. The metal cored welding electrode of claim 7, wherein the metal cored welding elected is formulated to produce an undiluted weld metal having a Cr/Mn-rich composition comprising ≦0.085 wt % C, ≦0.10 wt % Ni, 10.5-11.5 wt. % Cr, 6.0-7.5 wt % Mn, ≦0.35 wt % Si, ≦0.015 wt % Ti, ≦0.025 wt % Al, ≦0.025 wt % S, with the balance being Fe and incidental impurities.

9. A non-autogenous welding process comprising welding multiple sections of high strength steel together using the metal cored welding electrode of claim 1.

10. The non-autogenous welding process of claim 9, wherein the multiple sections of high strength steel are welded together using the metal cored welding electrode having the Cr/Ni-rich composition.

11. The non-autogenous welding process of claim 10, wherein the welding process is carried out in multiple successive welding passes to produce a multi-pass weld.

12. The non-autogenous welding process of claim 11, wherein the welding process is carried out in a manner so that the interpass temperature between the successive welding passes is maintained below 250° C.

13. The non-autogenous welding process of claim 12, wherein the interpass temperature between the successive welding passes is maintained at 100° C. to 180° C.

14. The non-autogenous welding process of claim 9, wherein the multiple sections of high strength steel are welded together using the metal cored welding electrode having the Cr/Mn-rich composition.

15. The non-autogenous welding process of claim 14, wherein the welding process is carried out in multiple successive welding passes to produce a multi-pass weld.

16. The non-autogenous welding process of claim 15, wherein the welding process is carried out in a manner so that the interpass temperature between the successive welding passes is maintained below 250° C.

17. The non-autogenous welding process of claim 16, wherein the interpass temperature between the successive welding passes is maintained at 100° C. to 180° C., for example.
